(19) United States
(12) Patent Application Publication
(10) Pub. No.: US 2010/0005881 A1
(43) Pub. Date: Jan. 14, 2010

(54) PROTECTIVE DEVICE FOR A HUMIDITY SENSOR IN AN AGGRESSIVE ATMOSPHERE

(76) Inventors: Axel Broedel, Lenzkirch (DE); Mike Muhl, Freiburg (DE)

Correspondence Address: MUIRHEAD AND SATURNELLI, LLC, 200 FRIBERG PARKWAY, SUITE 1001, WESTBOROUGH, MA, 01581, US

(21) Appl. No.: 12/309,383

(22) PCT Filed: Jun. 1, 2007
(86) PCT No.: PCT/EP2007/004900

§ 371 Date: Jul. 1, 2009

(30) Foreign Application Priority Data
Jul. 18, 2006 (DE) 102006033251.2

(51) Int. Cl. G01N 27/22

(52) U.S. Cl. 73/335.02

(57) ABSTRACT

A protective device for a humidity sensor protects the sensor from aggressive substances in a fluid to be analyzed. The protective device for the humidity sensor comprises a protective cap having openings that are covered with a membrane in such a manner that mass transfer between a measuring medium present in the environment and the interior of the protective cap can only take place through the membrane, said membrane including a plastic material which is highly permeable to water vapor, has high thermal stability and high corrosive resistance.

The present invention relates to a protective device for a humidity sensor whose purpose it is to protect the sensor from aggressive substances in a fluid to be analyzed.

Measuring the proportion of humidity in a heavily loaded, chemically aggressive atmosphere is a problem with regard to the technical measuring method, since many methods according to the related art are not usable or are only adaptable under substantial material and monetary expenditures because of the damaging effect of certain substances present in the fluid (i.e., in the measuring medium) to be analyzed. Moreover, many humidity sensors have cross sensitivities related to different substances present in the fluid to be analyzed which may distort the measuring result. An example for the measurement in a heavily loaded and chemically aggressive atmosphere is, for example, the measurement of the humidity of exhaust gas in exhaust systems.

A method for such purposes is known from the German Patent Application DE 41 42 118 A1, for example. In this method, the oxygen contents in a humid exhaust gas flow and in a dried reference gas flow are measured using a zirconium measuring element. The difference between the oxygen contents is a measure of the humidity content in the exhaust gas. A prerequisite for using this method is, however, that oxygen is present in the measuring gas. In addition, the equipment complexity is enormous.

Many of the known methods also use dew-point mirrors. However, these mirrors are only marginally suited for heavily loaded surroundings, because the mixture dew-point is measured—in an acidic atmosphere the acid dew-point—whereby the mirror is etched due to the fogging with the acidic solution and may thus be destroyed.

The use of cost-effective humidity sensor systems is mostly frustrated by the lack of resistance of the sensor material to aggressive substances and by the existing cross sensitivities and drift actions which are caused by the impact of these substances.

The object of the present invention is to provide a cost-effective and easy to handle humidity sensor which is suitable for use in a heavily loaded atmosphere, in particular in an acidic atmosphere.

This object is achieved by a protective device according to Claim 1 and a measuring chamber according to Claim 7. Advantageous embodiments and refinements are the subject matter of the subclaims.

The essential aspect of the present invention is the fact that instead of an appropriately robustly designed sensor, a cost-effective standard humidity sensor, e.g., a capacitive polymer humidity sensor, is used which is protected from the damaging effects of the surrounding atmosphere with the aid of a protective device. The protective device according to the present invention is, for example, a protective cap which encloses the sensor, or a separated area of a measuring chamber in which the sensor is situated. Due to this protective device, the sensor is gas-tightly separated from the atmosphere surrounding it. An exchange may simply take place via a diaphragm provided in the protective device.

On the one hand, this diaphragm must be capable of keeping all substances damaging to the sensor away from the sensor material, but at the same time it must be permeable to water or water vapor. A sulfonated tetrafluoroethylene polymer (PTFE), which is also known by its trade name, “Nafion,” is particularly well suited as a material for this purpose.

Nafion is very important as material for cation exchange diaphragms, e.g., in chlorine-alkali electrolysis and also in fuel cell technology. It is structurally similar to Teflon, is hydrophilic, cation-permeable as a thin foil and yet—like Teflon—chemically extremely resistant against heat (up to around 190° C.) and against acids and bases.

The permeability of Nafion to water vapor does not result from mechanical properties such as a certain pore size, but from a transport due to a chemical bonding of water. This transport takes place until the same water vapor partial pressure is present on both sides of the Nafion diaphragm. If the humidity content in the measuring medium changes outside the protective device, a transport of water or water vapor through the diaphragm takes place until the same water vapor partial pressures prevail on both sides of the diaphragm.

The humidity sensor inside the protective device always measures the humidity of the medium (mostly air or another defined atmosphere) inside the protective cap independently from the composition of the measuring medium outside the protective device, the Nafion diaphragm guaranteeing that the humidity content of the air inside the protective device is the same as in the measuring medium outside.

No cross sensitivities can occur as long as the diaphragm transports only water vapor, and furthermore the diaphragm keeps damaging substances away from the sensor.

However, in addition to water vapor there are other substances to which Nafion is permeable. They include, for example, alcohols or acetone, i.e., organic solvents having a hydroxyl group, ammonia, and hydrogen peroxide. The protective mechanism is not effective for these substances.

The main application of the present invention is the humidity measurement in a loaded air atmosphere. It would basically also be possible to carry out a measurement in fluids (e.g., measurement of the humidity content in oils). However, the operating mode of the diaphragm is no different from a measurement in a gas atmosphere. Instead of using a Nafion diaphragm, the sensor could also be coated directly with a layer of Nafion. The efficiency of such a protective layer is similar to a diaphragm.

The present invention is explained in greater detail in the following based on exemplary embodiments illustrated in the figures.

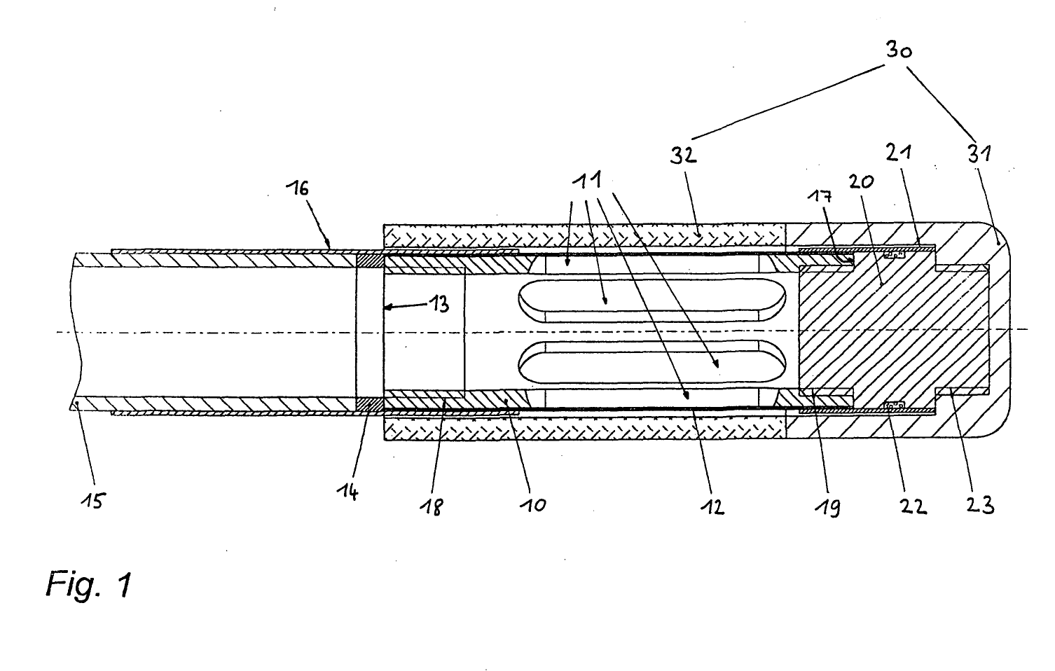

FIG. 1 shows a protective cap according to the present invention on a sensor tube for accommodating a humidity sensor.

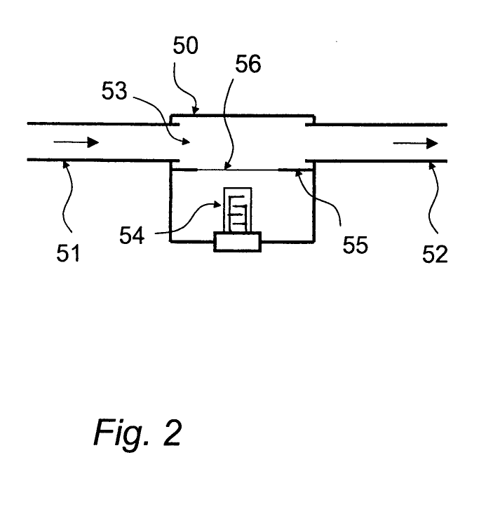

FIG. 2 shows a schematic representation of a measuring chamber through which the measuring medium to be analyzed may flow and in which the humidity sensor is separated from the rest of the measuring chamber by a partition wall having a Nafion diaphragm.

In the figures, the same reference numerals indicate the same components having the same relevance.

FIG. 1 shows a possible embodiment of a cylinder-shaped protective cap 10 made of stainless steel. This protective cap has slotted apertures 11 which are covered by a diaphragm 12 made of Nafion, so that water vapor may reach the interior of the protective cap exclusively through the diaphragm in the above-described manner. On a first end 13 of the protective cap the same is connected to a sensor tube 15 via a glass lead-through 14. This sensor tube is used for accommodating the feed lines to the sensor and for accommodating parts of the sensor electronics. Glass lead-through 14 is used as a gas-tight contact lead-through for the feed lines to the sensor. The connection between sensor tube 15 and protective cap 10 is additionally gas-tightly sealed using a shrink hose 16. Protective cap 10 has a thread on both ends. A humidity sensor, whose feed lines lead into sensor tube 15, is screwable into a first thread 18 at first end 13 of protective cap 10. A plug 20 made of Teflon is screwed into a second thread 19 at second end 17 of protective cap 10. This screw joint is also gas-tightly sealed using a shrink hose 21 which is additionally fixed using an adhesive 22. For this purpose, a suitable adhesive 22 is situated in a circular groove between Teflon plug 20 and shrink hose 21. At the end of plug 20, facing away from the protective cap, is another thread 23 onto which a further two-part cap 30 made of Teflon is screwed which completely encloses the protective cap and extends up to sensor tube 15. First part 31 of the cap, facing away from sensor tube 15, is made of solid Teflon; the second part, enclosing Nafion diaphragm 12 and stainless steel protective cap 10, is made of a porous Teflon sintered body 32 which is permeable to the measuring gas.

Teflon sintered body 32 may additionally be provided with a catalytic material so that certain substances in the measuring gas are catalytically broken down or decomposed when passing through the pores of sintered body 32. This is particularly important when there are substances in the measuring gas to which the Nafion diaphragm is permeable and which may still damage the sensor.

Such a substance is hydrogen peroxide (H₂O₂), for example. The Nafion diaphragm itself is permeable to hydrogen peroxide so that the diaphragm cannot protect the humidity sensor from the damaging effect of H₂O₂. For this reason, a catalytic material, in this case battery manganese (manganese dioxide), is situated in the pores of Teflon sintered body 32. The pores are large enough so that the measuring gas to be analyzed is able to pass through Teflon sintered body 32 in sufficient quantity and may reach the humidity sensor. The hydrogen peroxide contained in the measuring gas comes in contact with the catalyst to such an extent that a chemical reaction is triggered whereby the hydrogen peroxide is converted into water and oxygen. Due to this catalytic reduction, the hydrogen peroxide is practically entirely eliminated when passing through the porous sintered body 32.

Teflon does not necessarily have to be used as the material for plug 20 and outside cap 30; any other material having high temperature resistance and high resistance toward acids, bases, and similar damaging chemical effects is also suitable. Instead of using screw connections (18, 19, 23), other connections such as adhesive connections, soldered or welded connections are also conceivable.

Instead of Nafion, any other material which, in addition to the above-mentioned temperature resistance and chemical resistance, has a high selectivity for and permeability to water or water vapor may be used for diaphragm 12. As already mentioned, the permeability to water vapor does not result from mechanical properties, but rather from the transport through chemical bonding of water, so that a transport of substances from the surroundings into protective cap 10 is impossible with the exception via the described mechanism through the diaphragm. Since only water vapor reaches the interior of protective cap 10 through diaphragm 12, damage to the sensor due to corrosive or other aggressive substances is eliminated and cross sensitivities are avoided.

In FIG. 2, the humidity sensor is not enclosed by a protective cap but is installed in a measuring chamber 50. The measuring gas flows through the measuring chamber via two connectors 51 and 52. A humidity sensor 54 is situated in an area of interior space 53 of measuring chamber 50 which is separated from the rest of interior space 53 by a partition wall 55. This makes it possible that the gas flowing through cannot reach sensor 54 directly, but—like previously in protective cap 10—a humidity exchange takes place via one or multiple apertures in partition wall 55 which are covered by a Nafion diaphragm 56. In this embodiment of the present invention, the effect of diaphragm 56 is the same as in the example shown in FIG. 1.

Measuring chamber 50 may be placed in the space containing the measuring gas (e.g., an exhaust pipe) or it may be integrated into an exhaust probe for the exhaust gas analysis, for example. The supply and removal of the gas to be analyzed takes place via the two connectors, namely an intake 51 and an exhaust 52.

In a specific refinement of this embodiment, measuring chamber 50 and/or intake 51 are/is designed to be heatable and measuring chamber 50 is installed in a separate analyzer unit. Diaphragm 56 is either glued onto partition wall 55 or is removably attached. In this case, seals (sealing rings) are needed between diaphragm 56 and partition wall 55. For reasons already discussed, Teflon is particularly well suited as the material for measuring chamber 50 and also for partition wall 55.

### LIST OF REFERENCE NUMERALS

10 protective cap
11 slotted apertures
12 diaphragm made of Nafion
13 first end of 10
14 glass lead-through
15 sensor tube
16 shrink hose
17 second end
18 first thread
19 second thread
20 plug
21 shrink hose
22 adhesive
23 another thread
30 cap
31 first part of 30
32 second part of 30, sintered body
50 measuring chamber
51 first connector, intake
52 second connector, exhaust
53 interior space of 50
54 sensor
55 partition wall
56 diaphragm made of Nafion

1. A protective device for a humidity sensor, comprising:
a protective cap which has apertures which are covered by a diaphragm in such a way that a substance exchange between a measuring medium prevailing in the surroundings and an interior of the protective cap takes place through the diaphragm, the diaphragm being made of a plastic having a high permeability to water vapor, a high temperature resistance and a high resistance against corrosive substances.

2. The protective device as recited in claim 1, wherein the diaphragm is made of a sulfonated tetrafluoroethylene polymer.

3. The protective device as recited in claim 2, wherein the diaphragm is made of Nafion.

4. The protective device as recited in claim 1, wherein the protective cap has a porous protective body, and wherein the porous protective body includes a catalytically active substance situated as the outermost layer which eliminates the harmful substances in the measuring medium.

5. The protective device as recited in claim 4, wherein the porous protective body is a porous Teflon sintered body.

6. The protective device as recited in claim 4, wherein the catalytically active substance is manganese oxide.

7. A measuring chamber, comprising:
two connectors, and
a sensor situated in an interior space of the measuring chamber, wherein a measuring medium flowing through the interior space of the measuring chamber via the two connectors, and wherein the sensor is separated from the measuring medium by a partition wall having a diaphragm made of plastic with high permeability to water vapor, a high temperature resistance and a high resistance against corrosive substances.

8. The measuring chamber as recited in claim 7, wherein the diaphragm is made of a sulfonated tetrafluoroethylene polymer.

9. The measuring chamber as recited in claim 8, wherein the diaphragm is made of Nafion.

10. The measuring chamber as recited in claim 7, wherein the two connectors are designed to be heatable.

11. The measuring chamber as recited in claim 7, wherein the two connectors are heated.

12. The protective device as recited in claim 1, wherein the substance exchange occurs exclusively through the diaphragm.

13. A measurement device, comprising:
a sensor;
a protective device that protects the sensor, wherein the protective device includes:
a protective cap having at least one aperture;
a diaphragm covering the at least one aperture, wherein the diaphragm is made of a plastic having a high permeability to water vapor, a high temperature resistance and a high resistance to corrosive substances.

14. The measurement device according to claim 13, wherein the sensor is a humidity sensor.

15. The measurement device as recited in claim 13, wherein the diaphragm is made of a sulfonated tetrafluoroethylene polymer.

16. The measurement device as recited in claim 13, wherein the diaphragm is made of Nafion.

17. The measurement device as recited in claim 13, wherein the protective cap has a porous protective body, and wherein the porous protective body includes a catalytically active substance situated as the outermost layer.

18. The measurement device as recited in claim 17, wherein the porous protective body is a porous Teflon sintered body.

19. The measurement device as recited in claim 17, wherein the catalytically active substance is manganese oxide.

20. The measurement device as recited in claim 13, wherein the diaphragm is permeable to water vapor and impermeable to at least one damaging substance to the sensor.
